(19) United States
(12) Patent Application Publication
(10) Pub. No.: US 2026/0362287 A1
(43) Pub. Date: Nov. 12, 2026

(54) USER-EQUIPMENT-TO-USER-EQUIPMENT RELAYING

(71) Applicant: QUALCOMM Incorporated, San Diego, CA (US)

(72) Inventors: Karthika PALADUGU, Hyderabad (IN); Hong CHENG, Basking Ridge, NJ (US); Jianhua LIU, Beijing (CN); Shankar KRISHNAN, Poway, CA (US); Gavin Bernard HORN, La Jolla, CA (US)

(21) Appl. No.: 19/129,971

(22) PCT Filed: Feb. 3, 2023
(86) PCT No.: PCT/CN2023/074386

§ 371 Date: May 14, 2025

(51) Int. Cl. H04W 40/22

(52) U.S. Cl. CPC H04W 40/22

(57) ABSTRACT

Various aspects of the present disclosure generally relate to wireless communication. In some aspects, a source user equipment (UE) may transmit a route identifier for sidelink communications associated with UE-to-UE relaying. For a sidelink communication that is to be relayed between a source UE and a destination UE, a source UE may identify a route identifier that is based at least in part on one or more per-hop unicast link identifiers associated with the source UE and the relay UE. The per-hop unicast link identifiers may be different than an end-to-end unicast link identifier associated with a link between the source UE and the destination UE. In some aspects, the other route identifier may be the same as the route identifier used for the sidelink communication between the source UE and the relay UE. In some other aspects, the other route identifier may be a different route identifier.

### FIELD OF THE DISCLOSURE

Aspects of the present disclosure generally relate to wireless communication and specifically, to techniques and apparatuses for user-equipment-to-user-equipment relaying.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

One or more relay UEs may be configured to relay a communication between a source UE and a destination UE. Each hop between the source UE and the destination UE may include a UE pair and may be associated with a route identifier. However, in relay scenarios, such as multi-hop relay scenarios, a UE pair associated with a hop between the source UE and the destination UE may not be able to determine information that is to be included in the route identifier. For example, the UE pair may not be able to determine whether the route identifier is to be based on a per-hop unicast link identifier associated with the current hop, or an end-to-end unicast link identifier associated with the source UE and the destination UE. This may result in a relay UE not properly detecting a communication to be relayed between the source UE and the destination UE.

### SUMMARY

Some aspects described herein relate to a method of wireless communication performed by a source user equipment (UE). The method may include transmitting, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

Some aspects described herein relate to a method of wireless communication performed by a relay UE. The method may include identifying, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The method may include transmitting a sidelink communication, to the destination UE or another relay UE, that includes the route identifier.

Some aspects described herein relate to a source UE for wireless communication. The source UE may include at least one memory and at least one processor communicatively coupled with the at least one memory. The at least one processor may be operable to cause the source UE to transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

Some aspects described herein relate to a relay UE for wireless communication. The relay UE may include at least one memory and at least one processor communicatively coupled with the at least one memory. The at least one processor may be operable to cause the relay UE to identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The at least one processor may be operable to cause the relay UE to transmit a sidelink communication, to the destination UE or another relay UE, that includes the route identifier.

Some aspects described herein relate to a non-transitory computer-readable medium that stores a set of instructions for wireless communication by a source UE. The set of instructions, when executed by one or more processors of the UE, may cause the UE to transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

Some aspects described herein relate to a non-transitory computer-readable medium that stores a set of instructions for wireless communication by a relay UE. The set of instructions, when executed by one or more processors of the UE, may cause the UE to identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The set of instructions, when executed by one or more processors of the UE, may cause the UE to transmit a sidelink communication, to the destination UE or another relay UE, that includes the route identifier.

Some aspects described herein relate to an apparatus for wireless communication. The apparatus may include means for transmitting, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

Some aspects described herein relate to an apparatus for wireless communication. The apparatus may include means for identifying, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The apparatus may include means for transmitting a sidelink communication, to the destination UE or another relay UE, that includes the route identifier.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIGS. 5A-5D are diagrams illustrating examples of protocol stacks for UE-to-UE relaying, in accordance with the present disclosure.

FIG. 6 is a diagram illustrating an example of sidelink relay adaptation protocol (SRAP) layer communication for multi-hop relaying, in accordance with the present disclosure.

FIG. 7 is a diagram illustrating an example of an SRAP header format, in accordance with the present disclosure.

FIG. 8 is a diagram illustrating an example of UE-to-UE (U2U) relaying, in accordance with the present disclosure.

FIGS. 9A-9B are diagrams illustrating examples of route identification assignment, in accordance with the present disclosure.

FIG. 10 is a diagram illustrating an example of SRAP layer routing, in accordance with the present disclosure.

FIG. 11 is a flowchart illustrating an example process performed, for example, by a UE that supports U2U relaying in accordance with the present disclosure.

FIG. 12 is a flowchart illustrating an example process performed, for example, by a UE that supports U2U relaying in accordance with the present disclosure.

FIG. 13 is a diagram of an example apparatus for wireless communication that supports U2U relaying in accordance with the present disclosure.

FIG. 14 is a diagram of an example apparatus for wireless communication that supports U2U relaying in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to UE-to-UE (U2U) relaying. Some aspects more specifically relate to identifying and transmitting a route identifier for sidelink communications associated with U2U relaying. In some aspects, a source UE may identify a route identifier for a sidelink communication that is to be relayed between the source UE and a destination UE by one or more relay UEs. The route identifier may indicate a next-hop UE for relaying the sidelink communication between the source UE and the destination UE. The route identifier may be based on one or more per-hop unicast link identifiers associated with a link between the source UE and the relay UE. The per-hop unicast link identifiers are different than an end-to-end (E2E) unicast link identifier associated with a link between the source UE and the destination UE. The source UE may transmit a sidelink communication to the relay UE, for relaying to the destination UE, that includes the route identifier. The relay UE may receive the sidelink communication that includes the route identifier, may identify a next-hop UE for receiving the sidelink communication based on the route identifier, and may identify another route identifier that is to be used for relaying the sidelink communication between the relay UE and another UE. Thus, for each hop between the source UE and the destination UE, the route identifier may be updated based at least in part on information associated with the current hop UEs.

Particular aspects of the subject matter described in this disclosure can be implemented to realize one or more of the following potential advantages. In some examples, the described techniques can be used to increase a likelihood of sidelink communications being received by a next-hop UE and, ultimately, reaching the destination UE. In some examples, using the route identifier that is based on the per-hop unicast link identifier(s), rather than the E2E unicast link identifier, may reduce the need for collision management procedures by the relay UEs, thereby reducing system overhead.

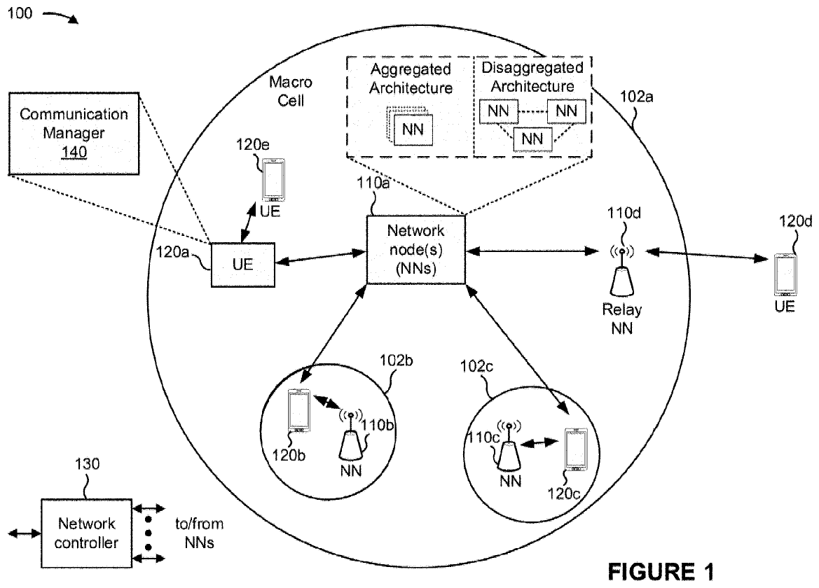

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FRI is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a source UE (for example, a UE 120) may include a communication manager 140. As described in more detail elsewhere herein, the communication manager 140 may transmit, to a relay UE (for example, a UE 120) for relaying to a destination UE (for example, a UE 120), a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE. Additionally or alternatively, the communication manager 140 may perform one or more other operations described herein.

In some aspects, a relay UE may include a communication manager 140. As described in more detail elsewhere herein, the communication manager 140 may identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE; and transmit a sidelink communication, to the destination UE or another relay UE, that includes the route identifier. Additionally or alternatively, the communication manager 140 may perform one or more other operations described herein.

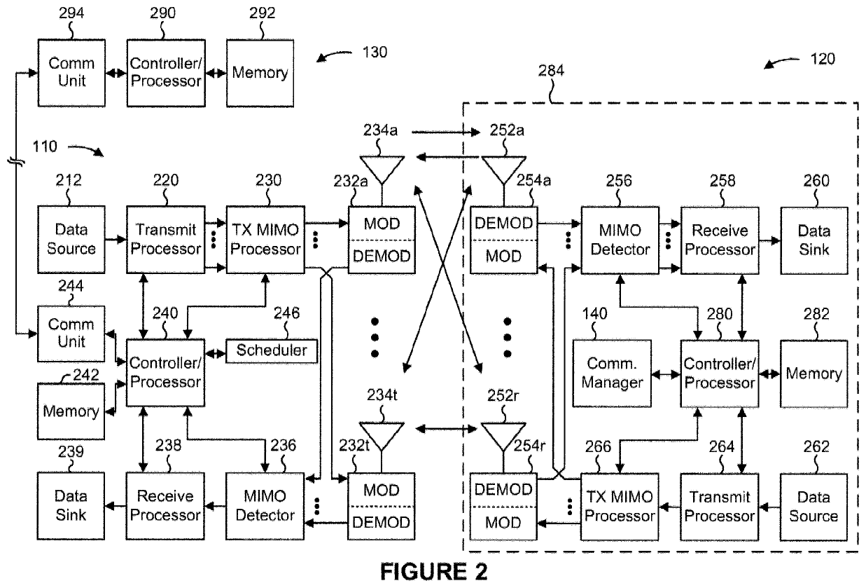

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

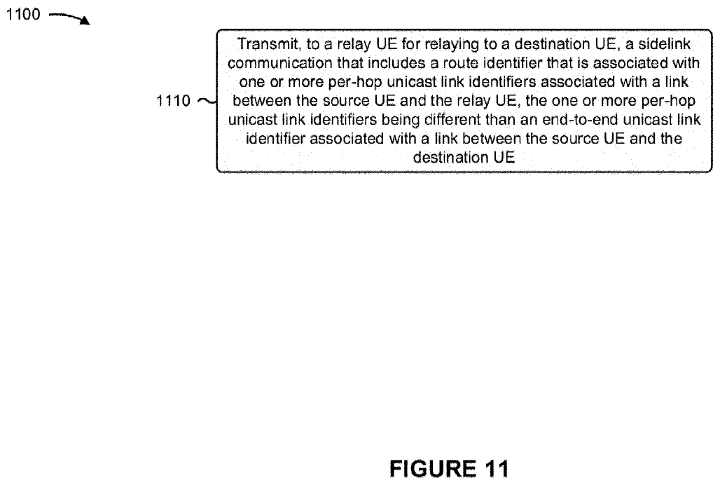

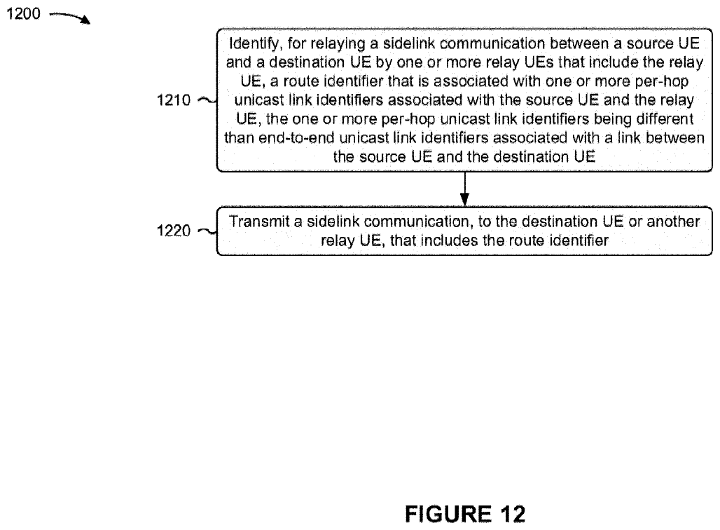

The controller/processor 240 of the network node 110, the controller/processor 280 of the UE 120, or any other component(s) of FIG. 2 may perform one or more techniques associated with UE-to-UE relaying, as described in more detail elsewhere herein. For example, the controller/processor 240 of the network node 110, the controller/processor 280 of the UE 120, or any other component(s) of FIG. 2 may perform or direct operations of, for example, process 1100 of FIG. 11, process 1200 of FIG. 12, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, a source UE (such as the UE 120) includes means for transmitting, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE. The means for the source UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a relay UE (such as the UE 120) includes means for identifying, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE; and/or means for transmitting a sidelink communication, to the destination UE or another relay UE, that includes the route identifier. The means for the relay UE to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

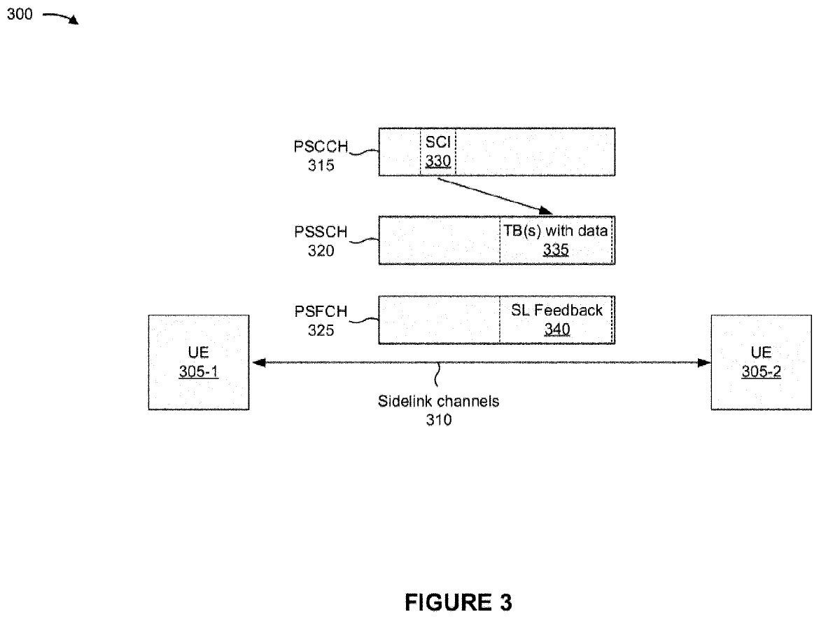

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (for example, which may include V2V communications, V2I communications, and/or V2P communications) and/or mesh networking. In some aspects, the UEs 305 (for example, UE 305-1 and/or UE 305-2) may correspond to one or more other UEs described elsewhere herein, such as UE 120. In some aspects, the one or more sidelink channels 310 may use a PC5 interface and/or may operate in a high frequency band (for example, the 5.9 GHz band). Additionally or alternatively, the UEs 305 may synchronize timing of transmission time intervals (TTIs) (for example, frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (for example, time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (for example, acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (for example, time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (for example, included in SCI 330) may be transmitted in sub-channels using specific resource blocks across time. In some aspects, data transmissions (for example, on the PSSCH 320) associated with a scheduling assignment may occupy adjacent resource blocks in the same subframe as the scheduling assignment (for example, using frequency division multiplexing). In some aspects, a scheduling assignment and associated data transmissions are not transmitted on adjacent resource blocks.

In some aspects, a UE 305 may operate using a sidelink transmission mode (for example, Mode 1) where resource selection and/or scheduling is performed by a network node 110 (for example, a base station, a CU, or a DU). For example, the UE 305 may receive a grant (for example, in downlink control information (DCI) or in a radio resource control (RRC) message, such as for configured grants) from the network node 110 (for example, directly or via one or more network nodes) for sidelink channel access and/or scheduling. In some aspects, a UE 305 may operate using a transmission mode (for example, Mode 2) where resource selection and/or scheduling is performed by the UE 305 (for example, rather than a network node 110). In some aspects, the UE 305 may perform resource selection and/or scheduling by sensing channel availability for transmissions. For example, the UE 305 may measure a received signal strength indicator (RSSI) parameter (for example, a sidelink-RSSI (S-RSSI) parameter) associated with various sidelink channels, may measure a reference signal received power (RSRP) parameter (for example, a PSSCH-RSRP parameter) associated with various sidelink channels, and/or may measure a reference signal received quality (RSRQ) parameter (for example, a PSSCH-RSRQ parameter) associated with various sidelink channels, and may select a channel for transmission of a sidelink communication based at least in part on the measurement(s).

Additionally or alternatively, the UE 305 may perform resource selection and/or scheduling using SCI 330 received in the PSCCH 315, which may indicate occupied resources and/or channel parameters. Additionally or alternatively, the UE 305 may perform resource selection and/or scheduling by determining a channel busy ratio (CBR) associated with various sidelink channels, which may be used for rate control (for example, by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (for example, transmission parameters) to be used for an upcoming sidelink transmission, such as one or more resource blocks to be used for the upcoming sidelink transmission on the PSSCH 320 (for example, for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally or alternatively, the UE 305 may generate a sidelink grant for event-driven scheduling, such as for an on-demand sidelink message.

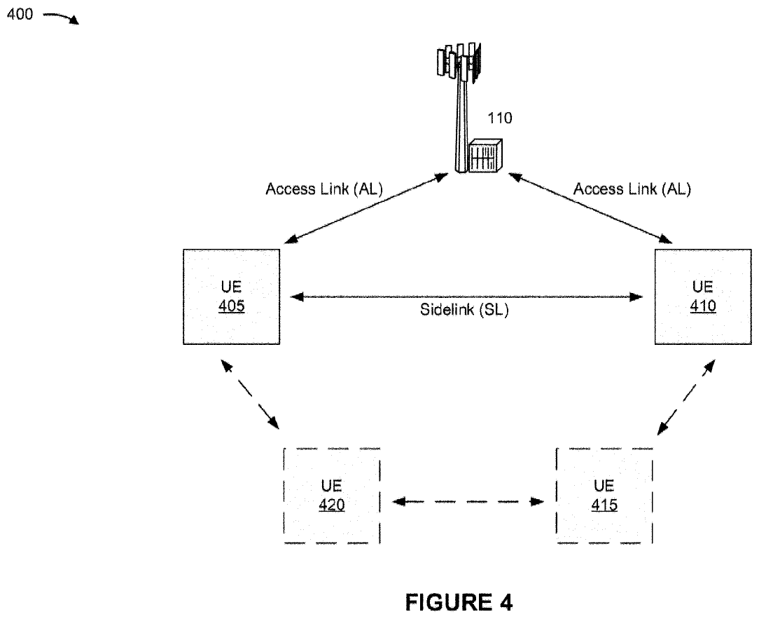

FIG. 4 is a diagram illustrating an example 400 of sidelink communications and access link communications, in accordance with the present disclosure.

As shown in FIG. 4, a UE 405 and a UE 410 may communicate with one another via a sidelink, as described above in connection with FIG. 3. As further shown, in some sidelink modes, a network node 110 may communicate with the UE 405 (for example, directly or via one or more network nodes), such as via a first access link. Additionally or alternatively, in some sidelink modes, the network node 110 may communicate with the UE 410 (for example, directly or via one or more network nodes), such as via a first access link. The UE 405 and/or the UE 410 may correspond to one or more UEs described elsewhere herein, such as the UE 120 of FIG. 1. Thus, a direct link between UEs 120 (for example, via a PC5 interface) may be referred to as a sidelink, and a direct link between a network 110 and a UE 120 (for example, via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some cases, at least one of the UE 405 and the UE 410 may be a relay UE. For example, the UE 405 may transmit a communication to the UE 410 via the sidelink interface, and the UE 410 may relay the communication to the network node 110 via the access link interface. This may be referred to as UE-to-network (U2N) relaying. In some cases, the UE 405 or the UE 410 may relay communications between two UEs. For example, the UE 405 may transmit a sidelink communication to the UE 410, and the UE 410 may relay the sidelink communication to another UE, such as the UE 415. This may be referred to as single-hop UE-to-UE (U2U) relaying. In some cases, at least two UEs may be involved in relaying a communication between two other UEs. For example, the UE 405 may transmit a sidelink communication to the UE 410, the UE 410 may relay the sidelink communication to the UE 415, and the UE 415 may relay the sidelink communication to another UE, such as the 420. This may be referred to as multi-hop U2U relaying.

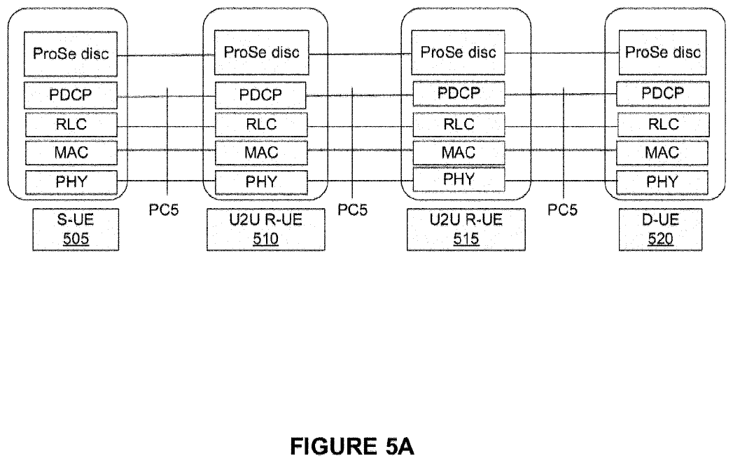

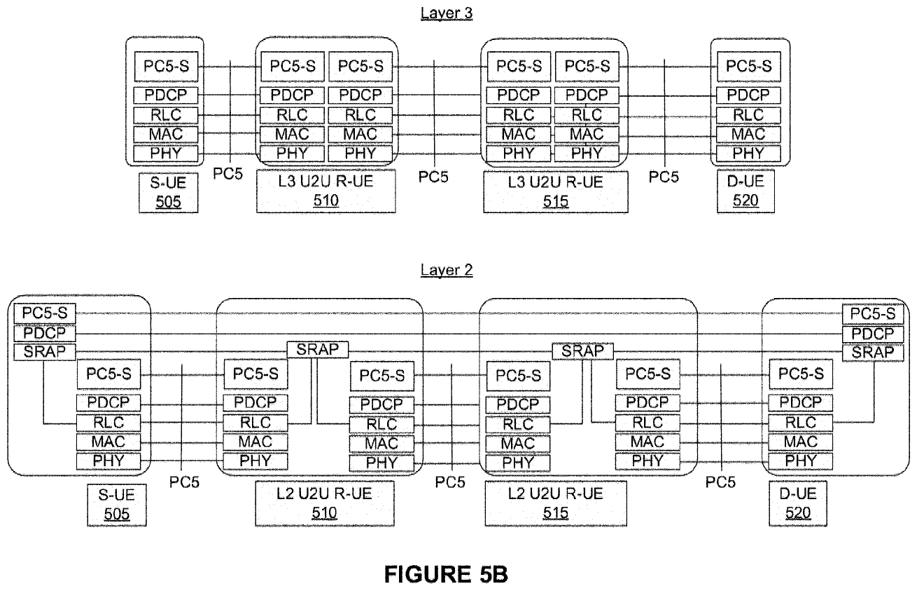

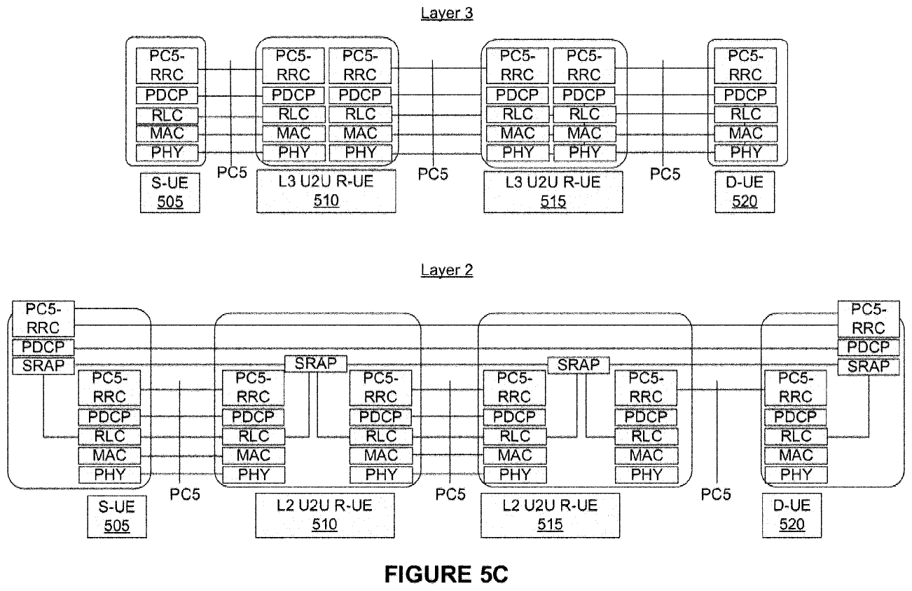

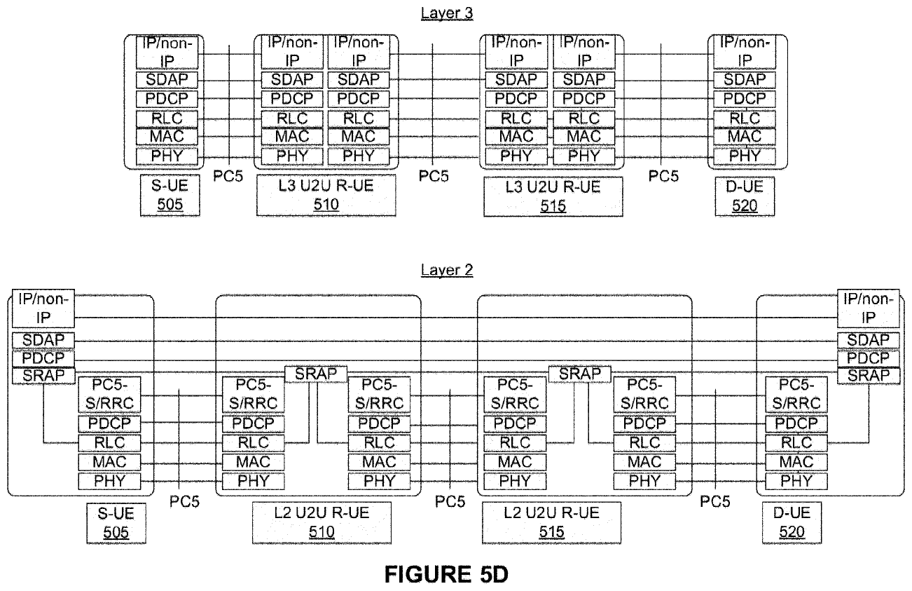

FIGS. 5A-5D are diagrams illustrating examples of protocol stacks for UE-to-UE relaying, in accordance with the present disclosure.

As shown in FIG. 5A, a protocol stack for the UE 120 includes a proximity services (ProSe) discovery layer, a packet data convergence protocol (PDCP) layer, a radio link control (RLC) layer, a medium access control (MAC) layer, and a physical (PHY) layer. The PHY layer may be referred to as Layer 1 (L1), and the PDCP, RLC, and MAC layers may collectively be referred to as Layer 2 (L2).

The ProSe layer may be used for performing UE-to-UE discovery and communication. UE-to-UE discovery using the ProSe layer may enable the UE 120 to use an air interface (such as an LTE or a 5G air interface) to identify other UEs that are in proximity to the UE 120. UE-to-UE communication using the ProSe layer may enable the UE 120 and another UE that is in proximity to the UE 120 to set up a direct communication link via the air interface without routing via the network node 110.

The PDCP layer may be used to map radio bearers to various RLC channels. For example, the PDCP layer may handle various services and functions on the user and control planes, including sequence numbering, header compression and decompression, transferring user data, reordering and duplicate detection, protocol data unit (PDU) routing, retransmission of PDCP service data units (SDU), ciphering and deciphering, PDCP SDU discard, PDCP re-establishment and data recovery for RLC acknowledged mode (AM), and duplication of PDCP PDUs, among other examples. The PDCP layer may provide data to the RLC layer in the form of PDCP PDUs via one or more RLC channels.

The RLC layer may perform transferring of upper layer PDUs to the MAC layer and/or the PHY layer, sequence numbering independent of the PDCP sequence numbering, error correction via automatic repeat requests (ARQs), segmentation and re-segmentation, reassembly of an SDU, RLC SDU discard, and RLC re-establishment. The RLC layer may provide data, mapped to logical channels, to the MAC layer.

The MAC layer may perform mapping between logical channels and transport channels (used by the PHY layer), multiplexing/demultiplexing of MAC SDUs belonging to one or more different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and/or padding, among other examples. The MAC layer may package data from logical channels into TBs, and may provide the TBs on one or more transport channels to the PHY layer.

The PHY layer may receive one or more TBs from the MAC layer via one or more transport channels. The PHY layer may handle various operations relating to the transmission of a data signal between the UE 120 and other devices such as other UEs and/or network nodes.

In some cases, a source UE (S-UE), such as the S-UE 505, may determine to perform a sidelink communication to a destination UE (D-UE), such as the D-UE 520. The ProSe discovery layer of the S-UE 505 may determine that the sidelink communication is to be routed from the S-UE 505 to the D-UE 520 through one or more relay UEs, such as the relay UE (R-UE) 510 and the R-UE 515. For example, the ProSe discovery layer of the S-UE 505 may determine that the S-UE 505 is unable to establish a direct communication link with the D-UE 520, for example, because the D-UE 520 is out of range of the S-UE 505, and may determine that the sidelink communication needs to be relayed via the R-UE 510 and the R-UE 515. A direct communication link may be established between the S-UE 505 and the R-UE 510, between the R-UE 510 and the R-UE 515, and between the R-UE 515 and the D-UE 520. The sidelink communication may be transmitted from the S-UE 505 to the R-UE 510, from the R-UE 510 to the R-UE 515, and from the R-UE 515 to the D-UE 520 using the PDCP, RLC, MAC, and PHY layers described above.

As shown in FIG. 5B, the S-UE 505, R-UE 510, R-UE 515, and D-UE 520 may communicate using Layer 3 (L3) UE-to-UE relaying. In Layer 3 UE-to-UE relaying, the R-UE supports relaying functionality at the L3/IP layer. Thus, the S-UE 505, R-UE 510, R-UE 515, and D-UE 520 setup the per-hop PC5 unicast link before relaying the user plane data. The S-UE 505 may communicate with a relay UE (such as the R-UE 510) using PC5-S signaling messages via a sidelink PC5 interface to setup the unicast link. For example, the S-UE 505 may communicate via the PC5-S layer of the S-UE 505 (and/or the PDCP layer, the RLC layer, the MAC layer, and the PHY layer) to communicate with a corresponding PC5-S layer (and/or a corresponding PDCP layer, RLC layer, MAC layer, and PHY layer) of the R-UE 510. The R-UE 510 may communicate via the PC5-S layer of the R-UE 510 (and/or the PDCP layer, the RLC layer, the MAC layer, and the PHY layer) to communicate with a corresponding PC5-S layer (and/or a corresponding PDCP layer, RLC layer, MAC layer, and PHY layer) of the R-UE 515. The R-UE 515 may communicate via the PC5-S layer of the R-UE 515 (and/or the PDCP layer, the RLC layer, the MAC layer, and the PHY layer) to communicate with a corresponding PC5-S layer (and/or a corresponding PDCP layer, RLC layer, MAC layer, and PHY layer) of the D-UE 520.

In some cases, the S-UE 505, the R-UE 510, the R-UE 515, and the D-UE 520 may communicate using Layer (L2) 2 UE-to-UE relaying. In L2 UE-to-UE relaying, the R-UE supports relaying functionality at the L2 via the sidelink relay adaptation protocol (SRAP) layer. In L2 UE-to-UE relaying, the S-UE 505, R-UE 510, R-UE 515, and D-UE 520 may setup per-hop unicast link(s) before setting the end-to-end unicast link between the S-UE 505 and D-UE 520. The S-UE 505 and the R-UE 510, the R-UE 510 and R-UE 515, and the R-UE 515 and D-UE 520, may communicate at PC5-S layer directly via a PC5-interface to setup a per-hop unicast link. In order to route the S-UE and D-UE end-to-end unicast link control plane signaling, a sidelink relay adaptation protocol (SRAP) layer may be used to identify routing information and perform routing for the control plane signaling. For example, the SRAP layer of the S-UE 505 may communicate with the SRAP layer of the R-UE 510 to identify routing information for communications between the S-UE 505 and the R-UE 510, the SRAP layer of the R-UE 510 may communicate with the SRAP layer of the R-UE 515 to identify routing information for communications between the R-UE 510 and the R-UE 515, and the SRAP layer of the R-UE 515 may communicate with the SRAP layer of the D-UE 520 to identify routing information for communications between the R-UE 515 and the D-UE 520. After direct communication or per-hop unicast links have been established between the S-UE 505 and the R-UE 510, between the R-UE 510 and the R-UE 515, and between the R-UE 515 and the D-UE 520 via the respective PC5 interfaces, a PC5-S layer and PDCP layer communication may be transmitted from the S-UE 505 to the D-UE 520 via the R-UE 510 and the R-UE 515 via the SRAP/RLC/MAC/PHY layers, as described herein.

As shown in FIG. 5C, the S-UE 505, R-UE 510, R-UE 515, and D-UE 520 may communicate using L3 UE-to-UE relaying. In L3 UE-to-UE relaying, the R-UE supports relaying functionality at the L3/IP layer. Thus, the S-UE 505, R-UE 510, R-UE 515, and D-UE 520 setup the per-hop PC5 unicast link before relaying the user plane data. The S-UE 505 may communicate with a relay UE (such as the R-UE 510) using PC5-RRC signaling messages via a sidelink PC5 interface to setup the unicast link. For example, the S-UE 505 may communicate via the PC5-RRC layer of the S-UE 505 (and/or the PDCP layer, the RLC layer, the MAC layer, and the PHY layer) to communicate with a corresponding PC5-RRC layer (and/or a corresponding PDCP layer, RLC layer, MAC layer, and PHY layer) of the R-UE 510. The R-UE 510 may communicate via the PC5-RRC layer of the R-UE 510 (and/or the PDCP layer, the RLC layer, the MAC layer, and the PHY layer) to communicate with a corresponding PC5-RRC layer (and/or a corresponding PDCP layer, RLC layer, MAC layer, and PHY layer) of the R-UE 515. The R-UE 515 may communicate via the PC5-RRC layer of the R-UE 515 (and/or the PDCP layer, the RLC layer, the MAC layer, and the PHY layer) to communicate with a corresponding PC5-RRC layer (and/or a corresponding PDCP layer, RLC layer, MAC layer, and PHY layer) of the D-UE 520.

In some cases, the S-UE 505, the R-UE 510, the R-UE 515, and the D-UE 520 may communicate using Layer 2 (L2) UE-to-UE relaying. In L2 UE-to-UE relaying, the R-UE supports relaying functionality at the L2 via the sidelink relay adaptation protocol (SRAP) layer. In L2 UE-to-UE relaying, the S-UE 505, R-UE 510, R-UE 515, and D-UE 520 may setup per-hop unicast link(s) before setting the end-to-end unicast link between the S-UE 505 and D-UE 520. The S-UE 505 and the R-UE 510, the R-UE 510 and R-UE 515, and the R-UE 515 and D-UE 520, may communicate at PC5-RRC layer directly via a PC5-interface to setup a per-hop unicast link. In order to route the S-UE and D-UE end-to-end unicast link control plane signaling, a sidelink relay adaptation protocol (SRAP) layer may be used to identify routing information and perform routing for the control plane signaling. For example, the SRAP layer of the S-UE 505 may communicate with the SRAP layer of the R-UE 510 to identify routing information for communications between the S-UE 505 and the R-UE 510, the SRAP layer of the R-UE 510 may communicate with the SRAP layer of the R-UE 515 to identify routing information for communications between the R-UE 510 and the R-UE 515, and the SRAP layer of the R-UE 515 may communicate with the SRAP layer of the D-UE 520 to identify routing information for communications between the R-UE 515 and the D-UE 520. After direct communication or per-hop unicast links have been established between the S-UE 505 and the R-UE 510, between the R-UE 510 and the R-UE 515, and between the R-UE 515 and the D-UE 520 via the respective PC5 interfaces, a PC5-RRC layer and PDCP layer communication may be transmitted from the S-UE 505 to the D-UE 520 via the R-UE 510 and the R-UE 515 via the SRAP/RLC/MAC/PHY layers, as described herein.

As shown in FIG. 5D, the S-UE 505, R-UE 510, R-UE 515, and D-UE 520 may communicate using L3 U2U relaying. The S-UE 505, R-UE 510, R-UE 515, and D-UE 520 setup the per-hop PC5 unicast link before relaying the user plane data. The S-UE 505 may communicate via the IP/non-IP layer of the S-UE 505 (and/or a service data adaption protocol (SDAP) layer, the PDCP layer, the RLC layer, the MAC layer, and/or the PHY layer) to communicate with a corresponding IP/non-IP layer (and/or a corresponding SDAP layer, PDCP layer, RLC layer, MAC layer, and PHY layer) of the R-UE 510. The R-UE 510 may communicate via the IP/non-IP layer of the R-UE 510 (and/or the SDAP layer, PDCP layer, the RLC layer, the MAC layer, and the PHY layer) to communicate with a corresponding IP/non-IP layer (and/or a corresponding SDAP layer, PDCP layer, RLC layer, MAC layer, and PHY layer) of the R-UE 515. The R-UE 515 may communicate via the IP/non-IP layer of the R-UE 515 (and/or the SDAP layer, PDCP layer, the RLC layer, the MAC layer, and the PHY layer) to communicate with a corresponding IP/non-IP layer (and/or a corresponding SDAP layer, PDCP layer, RLC layer, MAC layer, and PHY layer) of the D-UE 520.

In some cases, the S-UE 505, the R-UE 510, the R-UE 515, and the D-UE 520 may communicate using L2 U2U relaying. In some cases, the S-UE 505 and the D-UE 520 may communicate directly via an IP/non-IP layer, an SDAP layer, and a PDCP layer. For example, the S-UE 505 and the D-UE 520 may communicate directly using the IP/non-IP layer interface, the SDAP interface, and the PDCP interface based at least in part on establishing a direct link via an air interface. In some other cases, the S-UE 505 and the D-UE 520 may communicate via one or more relay UEs, such as the R-UE 510 and the R-UE 515. In this case, an SRAP layer may be used to identify routing information. For example, the SRAP layer of the S-UE 505 may communicate with the SRAP layer of the R-UE 510 to identify routing information for communications between the S-UE 505 and the R-UE 510, the SRAP layer of the R-UE 510 may communicate with the SRAP layer of the R-UE 515 to identify routing information for communications between the R-UE 510 and the R-UE 515, and the SRAP layer of the R-UE 515 may communicate with the SRAP layer of the D-UE 520 to identify routing information for communications between the R-UE 515 and the D-UE 520. After direct communication links have been established between the S-UE 505 and the R-UE 510, between the R-UE 510 and the R-UE 515, and between the R-UE 515 and the D-UE 520 via the respective IP/non-IP layer interfaces, an IP/non-IP layer, SDAP layer, and/or PDCP layer communication may be transmitted from the S-UE 505 to the D-UE 520 via the R-UE 510 and the R-UE 515, as described herein.

One or more relay UEs may be configured to relay a communication between a source UE and a destination UE. Each hop between the source UE and the destination UE may include a UE pair and may be associated with a route identifier. However, in relay scenarios, such as multi-hop relay scenarios, a UE pair associated with a hop between the source UE and the destination UE may not be able to determine information that is to be included in the route identifier. For example, the UE pair may not be able to determine whether the route identifier is to be based on a per-hop unicast link identifier associated with the current hop, or an end-to-end unicast link identifier associated with the source UE and the destination UE. This may result in a relay UE not properly detecting a communication to be relayed between the source UE and the destination UE.

Various aspects relate generally to U2U relaying. Some aspects more specifically relate to identifying and transmitting a route identifier for sidelink communications associated with U2U relaying. In some aspects, a source UE may identify a route identifier for a sidelink communication that is to be relayed between the source UE and a destination UE by one or more relay UEs. The route identifier may indicate a next-hop UE for relaying the sidelink communication between the source UE and the destination UE. The route identifier may be based on one or more per-hop unicast link identifiers associated with a link between the source UE and the relay UE. The per-hop unicast link identifiers are different than an E2E unicast link identifier associated with a link between the source UE and the destination UE. The source UE may transmit a sidelink communication to the relay UE, for relaying to the destination UE, that includes the route identifier. The relay UE may receive the sidelink communication that includes the route identifier, may identify a next-hop UE for receiving the sidelink communication based on the route identifier, and may identify another route identifier that is to be used for relaying the sidelink communication between the relay UE and another UE. Thus, for each hop between the source UE and the destination UE, the route identifier may be updated based at least in part on information associated with the current hop UEs.

Particular aspects of the subject matter described in this disclosure can be implemented to realize one or more of the following potential advantages. In some examples, the described techniques can be used to increase a likelihood of sidelink communications being received by a next-hop UE and, ultimately, reaching the destination UE. In some examples, using the route identifier that is based on the per-hop unicast link identifier(s), rather than the E2E unicast link identifier, may reduce the need for collision management procedures by the relay UEs, thereby reducing system overhead.

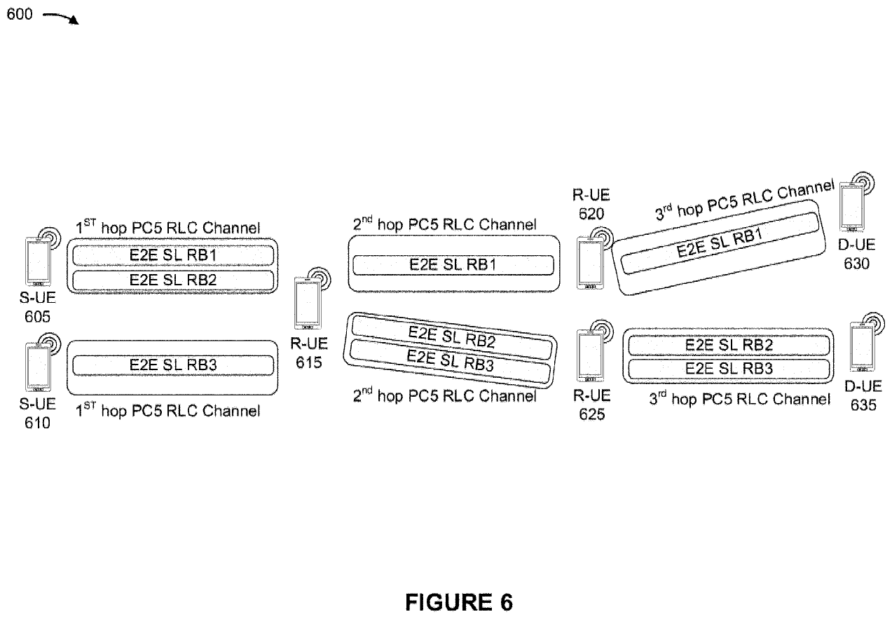

FIG. 6 is a diagram illustrating an example 600 of SRAP layer communication for multi-hop relaying, in accordance with the present disclosure.

An S-UE 605 and an S-UE 610 may be configured to perform one or more sidelink transmissions. For example, the S-UE 605 may be configured to perform a sidelink transmission to the R-UE 615 via a first end-to-end sidelink radio bearer (E2E SL RB1) and/or via a second end-to-end sidelink radio bearer (E2E SL RB2). Additionally or alternatively, the S-UE 610 may be configured to perform a sidelink transmission to the R-UE 615 via a third end-to-end sidelink radio bearer (E2E SL RB3). In some aspects, a per-hop unicast link may be multiplexed with traffic for different S-UE/D-UE pairs. The R-UE 615 may be configured to relay the sidelink transmission to the R-UE 620 via the E2E SL RB1 and/or may be configured to relay the sidelink transmission to the R-UE 625 via the E2E SL RB2 and/or the E2E SL RB3. The R-UE 620 may be configured to relay the sidelink transmission to the D-UE 630 via the E2E SL RB1, and the R-UE 625 may be configured to relay the sidelink transmission to the D-UE 635 via the E2E SL RB2 and/or the E2E SL RB3. In some aspects, an SRAP layer may be needed to perform data routing based at least in part on an SRAP header, to determine one or more SRAP header fields, to determine an egress link, and/or to determine an egress RLC channel, among other examples. As described in FIG. 6, each per-hop unicast link between the R-UEs, between the S-UE and R-UE, and between the R-UE and D-UE may be used to multiplex traffic corresponding to different S-UE/D-UE pairs. On each of the R-UEs, the SRAP layer may need to identify which S-UE/D-UE pair the SRAP PDU is to be used for routing the SRAP PDU on the appropriate per-hop unicast link. On the D-UE, when data from multiple S-UEs is multiplexed to the same per-hop unicast link between the D-UE and its neighbor R-UE, the SRAP layer may need to identify the PDCP entity for the corresponding SL RB of the S-UE to which the SRAP PDU has to been delivered. Thus, a route identifier may be needed in the SRAP layer to determine the routing of the SRAP PDU between the S-UE and D-UE via the R-UEs and the per-hop unicast links setup between the UEs.

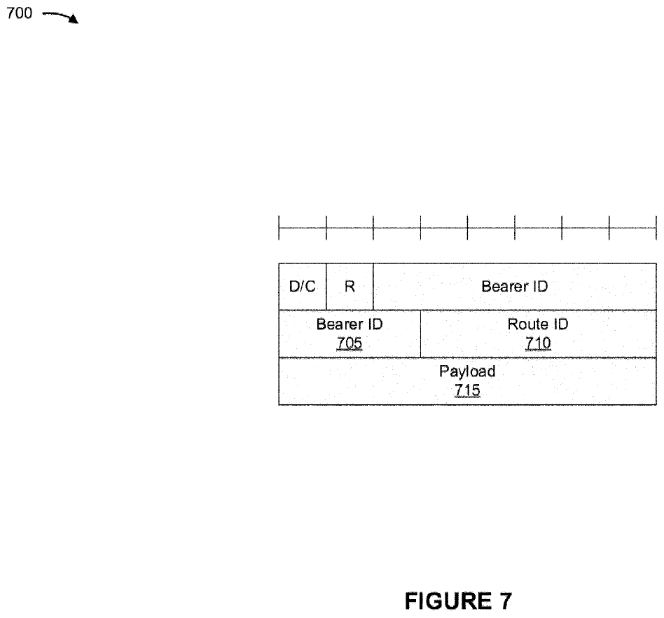

FIG. 7 is a diagram illustrating an example 700 of an SRAP header format, in accordance with the present disclosure. An SRAP header may include a data and control (D/C) field, a reserved bit (R), a bearer ID 705, a route ID 710, and a payload 715. The bearer ID 705 may identify a bearer that is used for communications between a UE and another UE (or between the UE and a network node). For example, the bearer ID 705 may be an E2E sidelink radio bearer ID that corresponds to an S-UE and D-UE E2E unicast link. The route ID 710 may identify the S-UE/D-UE pair for which the data corresponds to. The payload 715 may include the data that is to be communicated between the S-UE and the D-UE.

In the example of L2 U2U relaying, one or more relay UEs may be configured to relay a communication between a source UE and a destination UE using an SRAP layer. To route the data on the correct per-hop unicast link and PC5 RLC channel corresponding to the S-UE/D-UE pair (when multiplexing of data is supported), the S-UE/D-UE and the R-UEs may need to have a common understanding on the route identifier to use in the Route ID field of the SRAP header. In some examples, such as UE-to-network relaying where there is a network entity controlling the communications between the remote UE and relay UE, the network entity may determine the Route ID and may inform the remote UE and relay UE of the Route ID to use for data to be relayed between the remote UE and the network. However, in the case of UE-to-UE relaying, the UEs may or may not be in-coverage of a network and it may not be possible for a network entity to assign a route identifier for S-UE/D-UE pair and to notify the UEs on the multiple-hops. Techniques and apparatuses are described herein for determining a route identifier to be used by the S-UE, D-UE and R-UEs for relaying data between the S-UE and D-UE via one or more R-UEs. In some examples, the described techniques can be used to increase a likelihood of sidelink communications being received by a next-hop UE and, ultimately, reaching the destination UE.

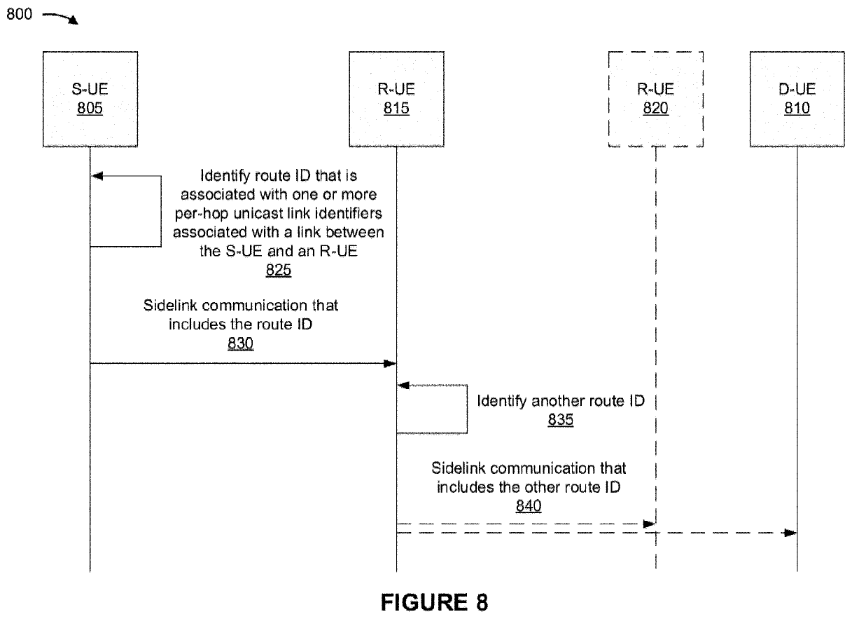

FIG. 8 is a diagram illustrating an example 800 of multi-hop UE-to-UE relaying, in accordance with the present disclosure. An S-UE 805 may communicate with a D-UE 810 via one or more R-UEs. For example, in a single-hop scenario, the S-UE 805 may communicate with the D-UE 810 via R-UE 815. In a multi-hop scenario, the S-UE 805 may communicate with the D-UE 810 via the R-UE 815 and at least one other R-UE, such as the R-UE 820.

In a first operation 825, the S-UE 805 or the R-UE 815 may identify a route ID to be used for a sidelink communication between the S-UE 805 and the D-UE 810 via one or more relay UEs. The route ID may be based at least in part on one or more per-hop unicast link IDs associated with a link between the source UE and the relay UE. The per-hop unicast link IDs may be different than E2E unicast link IDs associated with a link between the source UE and the destination UE. In some aspects, the S-UE 805 may receive the route ID from the R-UE 815. In some other aspects, the S-UE 805 may determine the route ID. For example, a ProSe layer of the S-UE 805 may determine the route ID based on the routing table constructed during discovery, and may transmit an indication of the route ID to an access stratum (AS) layer of the S-UE 805.

In some aspects (for example, a first option), the same route identifier may be used across all hops between the S-UE and D-UE. In this case, the route ID may be determined for each S-UE/D-UE pair on each UE based on at least one of the identifiers corresponding to the S-UE and D-UE services, the end-to-end unicast link between the S-UE and D-UE, and the per-hop link identifiers of the per-hop unicast links used for relaying data between S-UE and D-UE. In a first example, the route ID may correspond to a ProSe user information ID. The ProSe user information ID may be a 48-bit string. The ProSe layer may provide both S-UE and D-UE user information IDs for the AS layer to use in the route ID field of the SRAP header. Each R-UE and D-UE may be configured to independently determine the ProSe user information ID(s) from the upper layers or ProSe layer or from the SRAP header route ID to determine the S-UE/D-UE pair for which the data belongs to. In a second example, the route ID may be based at least in part on (for example, may be derived from) the ProSe user information ID. The ProSe layer or the AS layer may derive the route ID based at least in part on S-UE and/or D-UE user information IDs and a hash function. Each R-UE and D-UE may independently determine the ProSe user information ID(s), either from upper layers or ProSe layer or from the SRAP header route ID to determine the S-UE/D-UE pair for which the data belongs to. In a third example, the route ID may be based at least in part on an E2E link L2 ID. The E2E link L2 ID may be a 24-bit ID. The E2E link L2 ID may be identified during a discovery procedure. In the first, second and third example, the use of upper layer or ProSe layer identifiers to determine the route ID may increase the size of the SRAP header and also the implementation complexity due to the cross-layer interaction between the AS layer and the ProSe layer. In a fourth example, the route ID assigned may be configured or assigned by a central entity to the S-UE/D-UE and R-UEs to use for data routing between the S-UE and D-UE. This may not be possible if the UE is out of coverage. In a fifth example, a first hop R-UE (for example, the first R-UE after the S-UE) may assign the route ID for the S-UE/D-UE pair and may notify a neighbor UE of the route ID. The neighbor UE may forward route ID notification messages to other R-UEs or D-UEs to use the same route ID across all the hops for the routing the data between the S-UE and D-UE. In some aspects, a collision of route IDs may be possible when different R-UEs assign the same route ID. This may result in the need for a collision management protocol, which increases the complexity of using the same route ID across all hops.

In some aspects, (for example, a second option), a different route ID may be determined and/or assigned for each S-UE/D-UE pair to use in the SRAP header on each hop, where the route ID is unique on each per-hop unicast link. When multiple S-UE/D-UE pairs data is multiplexed on the same per-hop unicast link, and/or each of the S-UE/D-UE pairs is assigned a unique route ID, the SRAP layer can identify the S-UE/D-UE pair for which the SRAP PDU belongs to. As the route ID is different on each hop, the S-UE, R-UEs and D-UE may maintain an association of the route ID used on the per-hop unicast link to the S-UE/D-UE pair. In this case, each R-UE may assign the route ID to use for relaying the data corresponding to the S-UE/D-UE pair for the next hop and may notify the neighbor UEs of the route ID. The UEs (for example, the S-UE, the D-UE, and/or the R-UE) may maintain a mapping of the route ID to S-UE/D-UE routing information for the immediate hop. In this case, the uniqueness of the route ID is in the scope of each hop. Thus, no collision of route IDs is likely to occur on that hop. However, UEs may need to switch route IDs on one or more hops (for example, on each hop) until a packet reaches the D-UE.

In a second operation 830, the S-UE 805 may transmit, and the R-UE 815 may receive, a sidelink communication that includes the route ID.

In a third operation 835, the R-UE 815 may identify another route ID. For example, the R-UE 815 may determine another route ID to be used for a communication between the R-UE 815 and the D-UE 810 (for example, in a single-hop relay) or between the R-UE 815 and the R-UE 820 (for example, in a multi-hop relay). In some aspects, the other route ID may be the same route ID as the route ID used for the communication between the S-UE 805 and the R-UE 815. For example, as described in the first option, each hop between the S-UE 805 and the D-UE 810 may use the same route ID. In some other aspects, the other route ID may be a different route ID than the route ID used for the communication between the S-UE 805 and the D-UE 810. For example, as described in the second option, two or more hops (for example, all hops) between the S-UE 805 and the D-UE 810 may use different route identifiers.

In case of S-UE and D-UE directly connected over PC5 interface, the MAC and PHY layers use the L2 identifiers (source L2 ID and destination L2 ID) corresponding to the unicast link setup between them. For L2 relay communications, there may be two sets of L2 identifiers, such as E2E unicast link L2 identifiers and per-hop unicast link L2 identifiers. For L2 relay communications, as illustrated in FIG. 5D, the RLC, MAC and PHY layers of each per-hop unicast link may communicate. Thus, to transmit E2E sidelink (SL) radio bearer (RB) data using relaying (single-hop or multi-hop relaying), the L2 identifiers used by the MAC and PHY layers may include the per-hop unicast link L2 identifiers.

In some aspects, a ProSe layer of a UE (such as the S-UE 805 or the R-UE 815) may indicate, to an AS layer of the UE, the per-hop unicast link source and destination L2 IDs to be used for PC5-S messages. The AS layer may determine the source and destination L2 IDs for PC5-RRC messages based at least in part on the unicast link for which the messages are sent. In some aspects, the L2 IDs used for SL data may be based at least in part on a quality of service (QoS) flow mapping. For each PC5 QoS flow, the ProSe layer may provide, to the AS layer, a packet flow identity (PFI), QoS parameters, source and destination L2 IDs for broadcast and groupcast mode communications, and/or PC5 link IDs for unicast for the PC5 QOS flow. For U2U relaying (for example, single-hop or multi-hop), there may be two sets of L2 IDs, such as E2E unicast link L2 IDs and per-hop unicast link L2 IDs. To relay E2E SL RB data via U2U relaying, the L2 IDs to be used by the MAC or PHY layers should be the per-hop unicast link L2 IDs. The AS layer entities associated with the E2E unicast link may need to be provided with the per-hop unicast link L2 IDs determined based at least in part on a next hop in the routing table that is maintained at the ProSe layer. In some aspects, the ProSe layer may provide, to the AS layer, the per-hop unicast link L2 IDs to use along with the existing E2E unicast link L2 IDs for the unicast link. When provided with the per-hop unicast link L2 IDs, the MAC layer may use the per-hop unicast link L2 IDs for U2U relaying data.

In some aspects, an SRAP layer associated with a UE (for example, the S-UE 805 or the R-UE 815) may need to include a route ID and a bearer ID to include in the SRAP header for each relayed PDCP PDU. In L2 U2N relaying, the SRAP configuration may be provided by the Uu RRC and may be used by the SRAP entity. Alternatively, in L2 U2U relaying, the route ID configuration may be performed via PC5-S in the ProSe layer of the UE. Thus, for L2 U2U relaying, the ProSe layer of the UE may provide, to the AS layer of the UE, the route ID to be included in E2E PC5-S messages. The ProSe layer of the UE may provide, to the AS layer of the UE, the route ID in E2E unicast link information. The E2E unicast link information may also include L2 IDs, link IDs, and/or QoS information.

In some aspects, the ProSe layer of the R-UE 815 may provide, to the AS layer of the R-UE 815, the routing information for SRAP layer routing. In some aspects, the ProSe layer of the R-UE 815 may provide, to the AS layer of the R-UE 815, ingress per-hop link to egress per-hop link IDs based at least in part on next-hop information included in the routing table. In some aspects, the ProSe layer of the R-UE 815 may provide, to the AS layer of the R-UE 815, an ingress route ID to egress route ID mapping corresponding to the link on which an SRAP PDU is received.

In a fourth operation 840, the R-UE 815 may transmit a sidelink communication that includes the other route ID. For example, in the single hop scenario, the R-UE 815 may transmit a sidelink communication to the D-UE 810 that includes the other route ID. Alternatively, in a multi-hop scenario, the R-UE may transmit a sidelink communication to the R-UE 820 that includes the other route ID. As described herein, the other route ID may be the same route ID as the route ID used between the S-UE 805 and the R-UE 815 or may be a different route ID.

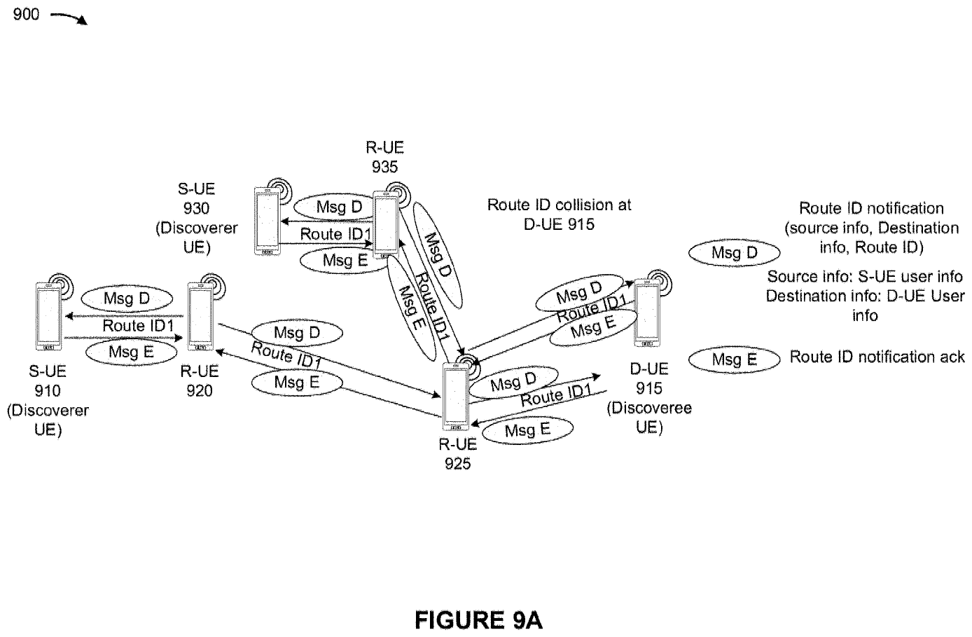

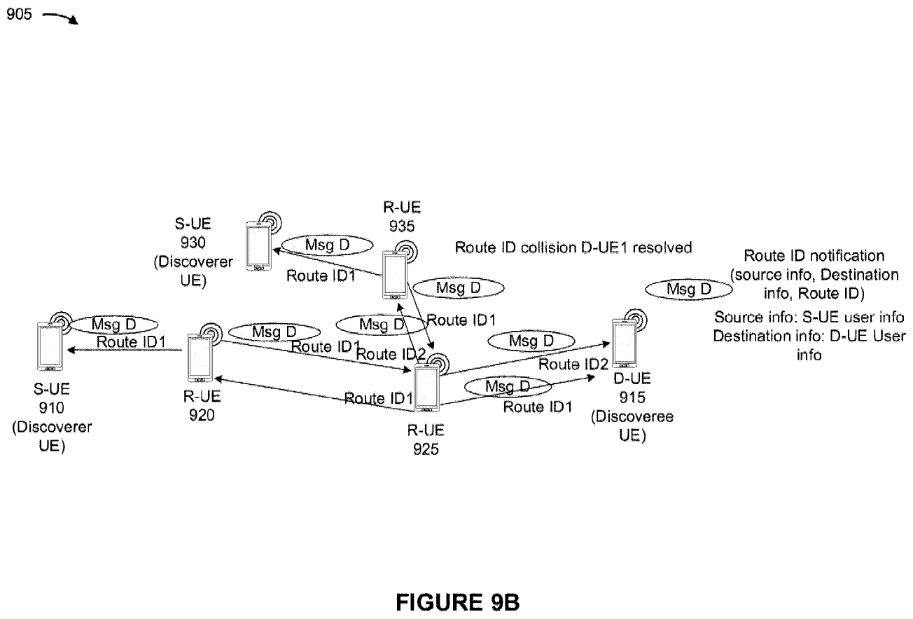

FIGS. 9A-9B are diagrams illustrating examples 900 and 905 of route identification assignment, in accordance with the present disclosure.

As shown in FIG. 9A, during a discovery procedure, an S-UE 910 (for example, a discoverer UE) may determine that a communication from the S-UE 910 can reach a D-UE 915 (a discovered UE) via a set of relays. For example, the S-UE 910 may determine that a communication from the S-UE 910 can reach the D-UE 915 via R-UE 920 and R-UE 925. The S-UE 910 and the R-UE 920 may establish a unicast link. The R-UE 920 may transmit a Message D to the S-UE 910. The Message D may be a route ID notification message, and may include source information, destination information, and the route ID. The source information may include S-UE 910 user information and the destination information may include D-UE 915 user information. The Message D may indicate that Route ID1 is to be used for communications between the S-UE 910 and the D-UE 915. The S-UE 910 may transmit a Message E to the R-UE 920. The Message E may be a route ID notification acknowledgement message. Additionally, the R-UE 915 may relay the Message D to the R-UE 925, and the R-UE 925 may relay the Message D to the D-UE 915. The D-UE 915 may receive the Message D, and may transmit a Message E to the R-UE 925. The R-UE 925 may relay the Message E to the R-UE 920. Thereafter, any communication between the S-UE 910 and the D-UE 915 may include the route identifier Route ID1.

In some aspects, an S-UE 930 (a discoverer UE) may attempt to communicate with the D-UE 915. For example, the S-UE 930 may determine that the S-UE 930 can communicate with the D-UE 915 via an R-UE 935 and the R-UE 925. The S-UE 930 and the R-UE 935 may not be able to determine that Route ID1 has been assigned for communications between the S-UE 910 and the D-UE 915. The R-UE 935 may transmit a Message D to the S-UE 930 that assigns Route ID1 as the route ID to be used for communications between the S-UE 930 and the D-UE 915. The S-UE 930 may transmit a Message E to the R-UE 935. The R-UE 935 may transmit a Message D to the R-UE 925 indicating that Route ID1 is to be used as the route ID for communications between the S-UE 930 and the D-UE 915. In this case, Route ID1 may be assigned for communications between the S-UE 910 and the D-UE 915 and for communications between the S-UE 930 and the D-UE 915. The R-UE 925 may need to perform collision management, such as a collision avoidance protocol, which may increase system overhead.

In some aspects, as described in the fifth example of the first option described herein, a first hop UE (R-UE 920) may assign the route ID and may notify the S-UE 910 during a per-hop unicast link setup. The R-UE 920 may notify the next hop UE (R-UE 925) of the route ID during the per-hop link setup. Each UE may maintain the relation between the S-UE/D-UE pair to the route ID.

In some aspects, the ProSe layers of the S-UE 910 and the D-UE 915 may perform relay discovery and selection. The R-UE 920 may transmit, and the S-UE 910 may receive, a ProSe direct link establishment accept message that includes the route ID (Route ID1) for the S-UE/D-UE pair. The R-UE 920 may transmit, and the R-UE 925 may receive, a ProSe direct link security mode complete message that includes the route ID (Route ID1) for the S-UE/D-UE pair. The R-UE 925 may transmit, and the D-UE 915 may receive, a ProSe direct link security mode complete message that includes the route ID (Route ID1) for the S-UE/D-UE pair.

In some aspects, the unicast link may be modified. For example, a unicast link may be modified to update the route ID based at least in part on a collision avoidance procedure. The R-UE 920 may transmit, and the S-UE 910 may receive, a ProSe direct link modification message that includes the updated route ID (Route ID2) for the S-UE/D-UE pair. The R-UE 920 may transmit, and the R-UE 925 may receive, a ProSe direct link modification message that includes the updated route ID (Route ID2) for the S-UE/D-UE pair. The R-UE 925 may transmit, and the D-UE 915 may receive, a ProSe direct link modification message that includes the updated route ID (Route ID2) for the S-UE/D-UE pair.

As shown in FIG. 9B, the R-UE 920 may transmit a Message D to the S-UE 910 that indicates to use Route ID1 as the route ID for communications between the S-UE 910 and the D-UE 915. Additionally, the R-UE 920 may transmit a Message D to the R-UE 925 that indicates to use Route ID1 as the route ID for communications between the S-UE 910 and the D-UE 915. The R-UE 925 may transmit a Message D to the D-UE 915 that indicates to use Route ID2 as the route ID for communications between the S-UE 910 and the D-UE 915. Additionally, the R-UE 925 may transmit a Message D to the R-UE 935 that indicates to use Route ID2 as the route ID for communications between the S-UE 910 and the D-UE 915. Thus, in accordance with the second option described herein, each R-UE assigns the route ID for the S-UE/D-UE pair for which a unicast link is set up or modified, and notifies the selected next-hop neighbor UEs of the route ID. Each UE maintains the relation between the S-UE/D-UE pair to the Route ID.

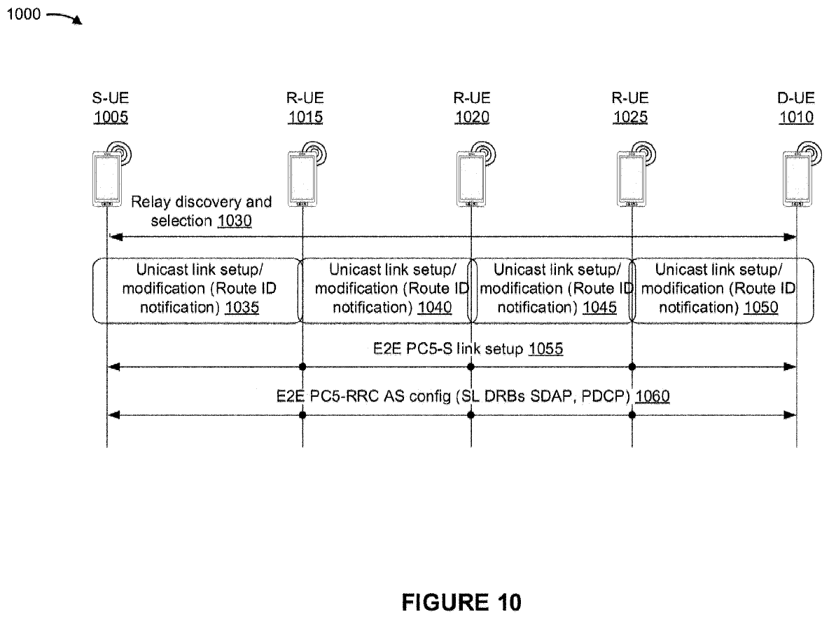

FIG. 10 is a diagram illustrating an example 1000 of SRAP layer routing, in accordance with the present disclosure.

In a first operation 1030, a plurality of UEs may perform relay discovery and selection. For example, an S-UE 1005 may determine that, for a sidelink communication to reach the D-UE 1010, the communication is to be relayed via the R-UE 1015, the R-UE 1020, and the R-UE 1025.

In a second operation 1035, the S-UE 1005 and the R-UE 1015 may perform a unicast link setup or modification. The unicast link setup or modification may include an indication of a route ID. In a third operation 1040, the R-UE 1015 and the R-UE 1020 may perform a unicast link setup or modification. The unicast link setup or modification may include an indication of a route ID. The route ID may be the same as the route ID used for the unicast link setup or modification between the S-UE 1005 and the R-UE 1015, or may be a different route ID. In a fourth operation 1045, the R-UE 1020 and the R-UE 1025 may perform a unicast link setup or modification. The unicast link setup or modification may include an indication of a route ID. The route ID may be the same as the route ID used for one of the previous unicast link setup or modifications, or may be a different route ID. In a fifth operation 1050, the R-UE 1025 and the D-UE 1010 may perform a unicast link setup or modification. The unicast link setup or modification may include an indication of a route ID. The route ID may be the same as the route ID used for one of the previous unicast link setup or modifications, or may be a different route ID.

In a sixth operation 1055, the UEs may perform an E2E PC5-S link setup. In a seventh operation 1060, the UEs may perform E2E PC5-RRC AS configuration. The E2E PC5-RRC AS configuration may include configuring one or more of an SL data radio bearer (DRB) configuration, an SDAP configuration, or a PDCP configuration, among other examples.

In some aspects, the S-UE 1005 may set the route ID as provided by the ProSe layer for E2E sidelink radio bearer (SRB) PDCP PDUs. The S-UE 1005 SRAP layer may set the bearer ID to the E2E SL SRB ID (for example, SL SRB0-3 ID). The SRAP layer may use a default bearer mapping configuration for the E2E SL SRB data.

In some aspects, the S-UE 1005 may set the route ID as provided by the ProSe layer for the E2E unicast link. The S-UE 1005 SRAP layer may set the bearer ID to the E2E SL DRB ID. The SRAP layer may use a default bearer mapping configuration for the E2E SL DRB data.

FIG. 11 is a flowchart illustrating an example process 1100 performed, for example, by a UE (e.g., a source UE) that supports U2U relaying in accordance with the present disclosure. Example process 1100 is an example where the UE (for example, UE 120) performs operations associated with U2U relaying.

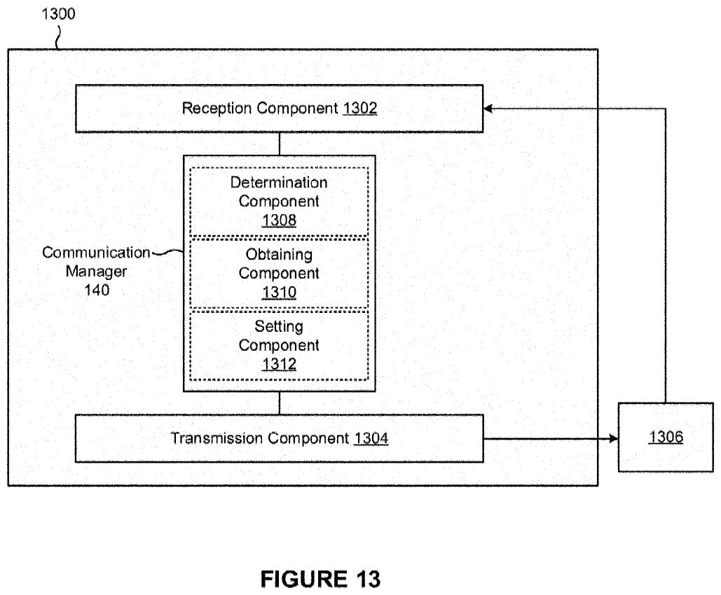

As shown in FIG. 11, in some aspects, process 1100 may include transmitting, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE (block 1110). For example, the UE (such as by using communication manager 140 or transmission component 1304, depicted in FIG. 13) may transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE, as described above.

Process 1100 may include additional aspects, such as any single aspect or any combination of aspects described below or in connection with one or more other processes described elsewhere herein.

In a first additional aspect, the route identifier for a current hop between the source UE and the relay UE is the same as a route identifier used for each of one or more other hops.

In a second additional aspect, alone or in combination with the first aspect, process 1100 includes receiving the route identifier from the relay UE.

In a third additional aspect, alone or in combination with one or more of the first and second aspects, process 1100 includes determining the route identifier by a proximity services layer of the source UE.

In a fourth additional aspect, alone or in combination with one or more of the first through third aspects, process 1100 includes obtaining, by a proximity services layer of the source UE, an end-to-end unicast link L2 identifier associated with the link between the source UE and the destination UE and a per-hop unicast link L2 identifier associated with the link between the source UE and the relay UE; providing, by the proximity services layer of the source UE to an access stratum layer of the source UE, at least the per-hop unicast link L2 identifiers; and obtaining, by the access stratum layer of the source UE, the route identifier.

In a fifth additional aspect, alone or in combination with one or more of the first through fourth aspects, process 1100 includes setting, by an SRAP layer of the source UE, the route identifier for the sidelink communication to be equal to the route identifier obtained from the proximity services layer of the source UE, wherein the sidelink communication includes an E2E SL SRB PDCP PDU.

In a sixth additional aspect, alone or in combination with one or more of the first through fifth aspects, process 1100 includes setting, by the SRAP layer of the source UE, a bearer identifier for the sidelink communication to be equal to an E2E SL SRB identifier associated with the link between the source UE and the destination UE.

In a seventh additional aspect, alone or in combination with one or more of the first through sixth aspects, the sidelink communication corresponds to E2E SL SRB data and is supported using a default bearer mapping configuration between an E2E SL SRB identifier and a PC5 RLC channel identifier associated with the link between the source UE and the relay UE.

In an eighth additional aspect, alone or in combination with one or more of the first through seventh aspects, process 1100 includes setting, by an SRAP layer of the source UE, the route identifier for the sidelink communication to be equal to the route identifier obtained from the proximity services layer of the source UE, wherein the sidelink communication is associated with an E2E unicast link between the source UE and the relay UE.

In a ninth additional aspect, alone or in combination with one or more of the first through eighth aspects, process 1100 includes setting, by the SRAP layer of the source UE, a bearer identifier for the sidelink communication to be equal to an E2E SL DRB identifier associated with the link between the source UE and the relay UE.

In a tenth additional aspect, alone or in combination with one or more of the first through ninth aspects, the sidelink communication corresponds to E2E SL DRB data and is supported using a bearer mapping configuration between the E2E SL DRB identifier and a PC5 RLC channel identifier associated with the link between the source UE and the relay UE.

In an eleventh additional aspect, alone or in combination with one or more of the first through tenth aspects, a proximity services layer of the source UE provides the route identifier to an access stratum layer of the source UE to be used with one or more sidelink PC5 messages.

In a twelfth additional aspect, alone or in combination with one or more of the first through eleventh aspects, a proximity services layer of the source UE provides the route identifier to an access stratum layer of the source UE as part of E2E unicast link information, wherein the E2E unicast link information includes at least one of a layer 2 identifier or a quality of service indicator.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a UE (e.g., a relay UE) that supports U2U relaying in accordance with the present disclosure. Example process 1200 is an example where the UE (for example, UE 120) performs operations associated with U2U relaying.

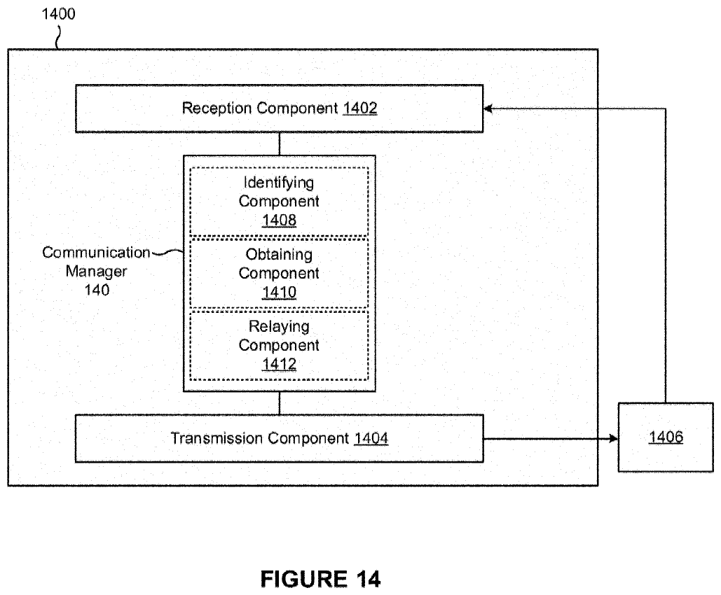

As shown in FIG. 12, in some aspects, process 1200 may include identifying, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE (block 1210). For example, the UE (such as by using communication manager 140 or identifying component 1408, depicted in FIG. 14) may identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE, as described above.

As further shown in FIG. 12, in some aspects, process 1200 may include transmitting a sidelink communication, to the destination UE or another relay UE, that includes the route identifier (block 1220). For example, the UE (such as by using communication manager 140 or transmission component 1404, depicted in FIG. 14) may transmit a sidelink communication, to the destination UE or another relay UE, that includes the route identifier, as described above.

Process 1200 may include additional aspects, such as any single aspect or any combination of aspects described below or in connection with one or more other processes described elsewhere herein.

In a first additional aspect, process 1200 includes obtaining, by an access stratum layer of the relay UE from a proximity services layer of the relay UE, routing information for SRAP layer relaying between a source UE and another relay UE, receiving a sidelink communication from the source UE, and relaying the sidelink communication to the other relay UE or a destination UE using the routing information.

In a second additional aspect, alone or in combination with the first aspect, obtaining the routing information comprises assigning the route identifier for a link between the source UE and the destination UE and transmitting an indication of the route identifier to the source UE during a per-hop unicast link setup or modification between the relay UE and the source UE.

In a third additional aspect, alone or in combination with one or more of the first and second aspects, process 1200 includes transmitting an indication of the route identifier to the other relay UE during a per-hop unicast link setup or modification between the relay UE and the other relay UE.

In a fourth additional aspect, alone or in combination with one or more of the first through third aspects, the relay UE is a first-hop relay UE from the source UE, and the route identifier is used for each hop between the source UE and the destination UE.

In a fifth additional aspect, alone or in combination with one or more of the first through fourth aspects, two or more hops between the source UE and the destination UE are associated with different route identifiers.

In a sixth additional aspect, alone or in combination with one or more of the first through fifth aspects, process 1200 includes maintaining, by the relay UE, a mapping between the route identifier and the source UE and destination UE identifiers, where the source UE and destination UE identifiers include at least one of user information, E2E unicast link layer 2 identifiers, or per-hop unicast link layer 2 identifiers.

In a seventh additional aspect, alone or in combination with one or more of the first through sixth aspects, routing information maintained by the relay UE includes a mapping of an ingress per-hop link identifier to egress per-hop link identifier.

In an eighth additional aspect, alone or in combination with one or more of the first through seventh aspects, a proximity services layer of the relay UE provides the ingress per-hop link to egress per-hop link identifier to an access stratum layer of the relay UE using next-hop routing information that is included in a routing table for a source UE and destination UE pair.

In a ninth additional aspect, alone or in combination with one or more of the first through eighth aspects, routing information maintained by the relay UE includes an ingress route to egress route identifier.

In a tenth additional aspect, alone or in combination with one or more of the first through ninth aspects, the ingress route to egress route identifier is associated with a link on which the sidelink communication is received.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports U2U relaying in accordance with the present disclosure. The apparatus 1300 may be a source UE, or a source UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 6-10. Additionally or alternatively, the apparatus 1300 may be configured to and/or operable to perform one or more processes described herein, such as process 1100 of FIG. 11. In some aspects, the apparatus 1300 may include one or more components of the source UE described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, and/or a memory of the source UE described above in connection with FIG. 2.

The transmission component 1304 may transmit communications, such as reference signals, control information, and/or data communications, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, and/or a memory of the source UE described above in connection with FIG. 2. In some aspects, the transmission component 1304 may be co-located with the reception component 1302 in a transceiver.

The communication manager 140 may transmit or may cause the transmission component 1304 to transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE. In some aspects, the communication manager 140 may perform one or more operations described elsewhere herein as being performed by one or more components of the communication manager 140.

The communication manager 140 may include a controller/processor and/or a memory of the source UE described above in connection with FIG. 2. In some aspects, the communication manager 140 includes a set of components, such as a determination component 1308, an obtaining component 1310, and/or a setting component 1312. Alternatively, the set of components may be separate and distinct from the communication manager 140. In some aspects, one or more components of the set of components may include or may be implemented within a controller/processor and/or a memory of the source UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1304 may transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

The reception component 1302 may receive an indication of the route identifier from the relay UE. The determination component 1308 may determine the route identifier by a proximity services layer of the source UE. The obtaining component 1310 may obtain end-to-end unicast link L2 identifiers and per-hop unicast link L2 identifiers. The transmission component 1304 may provide at least the per-hop unicast link L2 identifiers. The obtaining component 1310 may obtain the route identifier. The setting component 1312 may set the route identifier for the sidelink communication to be equal to the route identifier obtained from the proximity services layer of the source UE, wherein the sidelink communication includes an E2E SL SRB PDCP PDU. The setting component 1312 may set a bearer identifier for the sidelink communication to be equal to an E2E SL SRB identifier associated with the link between the source UE and the destination UE. The setting component 1312 may set the route identifier for the sidelink communication to be equal to the route identifier obtained from the proximity services layer of the source UE, wherein the sidelink communication is associated with an E2E unicast link between the source UE and the relay UE. The setting component 1312 may set a bearer identifier for the sidelink communication to be equal to the E2E SL DRB identifier.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports U2U relaying in accordance with the present disclosure. The apparatus 1400 may be a relay UE, or a relay UE may include the apparatus 1400. In some aspects, the apparatus 1400 includes a reception component 1402, a transmission component 1404, and a communication manager 140, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 6-10. Additionally or alternatively, the apparatus 1400 may be configured to and/or operable to perform one or more processes described herein, such as process 1200 of FIG. 12. In some aspects, the apparatus 1400 may include one or more components of the relay UE described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 140. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, and/or a memory of the relay UE described above in connection with FIG. 2.

The transmission component 1404 may transmit communications, such as reference signals, control information, and/or data communications, to the apparatus 1406. In some aspects, the communication manager 140 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, and/or a memory of the relay UE described above in connection with FIG. 2. In some aspects, the transmission component 1404 may be co-located with the reception component 1402 in a transceiver.

The communication manager 140 may identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The communication manager 140 may transmit or may cause the transmission component 1404 to transmit a sidelink communication, to the destination UE or another relay UE, that includes the route identifier. In some aspects, the communication manager 140 may perform one or more operations described elsewhere herein as being performed by one or more components of the communication manager 140.

The communication manager 140 may include a controller/processor and/or a memory of the relay UE described above in connection with FIG. 2. In some aspects, the communication manager 140 includes a set of components, such as an identifying component 1408, an obtaining component 1410, and/or a relaying component 1412. Alternatively, the set of components may be separate and distinct from the communication manager 140. In some aspects, one or more components of the set of components may include or may be implemented within a controller/processor and/or a memory of the relay UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The identifying component 1408 may identify, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE. The transmission component 1404 may transmit a sidelink communication, to the destination UE or another relay UE, that includes the route identifier.

The obtaining component 1410 may obtain routing information for SRAP layer relaying between a source UE and another relay UE. The reception component 1402 may receive a sidelink communication from the source UE. The relaying component 1412 may relay the sidelink communication to the other relay UE or a destination UE using the routing information. The transmission component 1404 may transmit an indication of the route identifier to the other relay UE during a per-hop unicast link setup or modification between the relay UE and the other relay UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a source user equipment (UE), comprising: transmitting, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

Aspect 2: The method of Aspect 1, wherein the route identifier for a current hop between the source UE and the relay UE is the same as a route identifier used for each of one or more other hops.

Aspect 3: The method of any of Aspects 1-2, further comprising receiving the route identifier from the relay UE.

Aspect 4: The method of any of Aspects 1-3, further comprising determining the route identifier by a proximity services layer of the source UE.

Aspect 5: The method of Aspect 4, further comprising: obtaining, by a proximity services layer of the source UE, an end-to-end unicast link layer two (L2) identifier associated with the link between the source UE and the destination UE and a per-hop unicast link L2 identifier associated with the link between the source UE and the relay UE; providing, by the proximity services layer of the source UE to an access stratum layer of the source UE, at least the per-hop unicast link L2 identifiers; and obtaining, by the access stratum layer of the source UE, the route identifier.

Aspect 6: The method of Aspect 5, further comprising setting, by a sidelink relay adaptation protocol (SRAP) layer of the source UE, the route identifier for the sidelink communication to be equal to the route identifier obtained from the proximity services layer of the source UE, wherein the sidelink communication includes an end-to-end (E2E) sidelink (SL) signaling radio bearer (SRB) packet data convergence protocol (PDCP) protocol data unit (PDU).

Aspect 7: The method of Aspect 6, further comprising setting, by the SRAP layer of the source UE, a bearer identifier for the sidelink communication to be equal to an E2E SL SRB identifier associated with the link between the source UE and the destination UE.

Aspect 8: The method of Aspect 7, wherein the sidelink communication corresponds to E2E SL SRB data and is supported using a default bearer mapping configuration between an E2E SL SRB identifier and a PC5 radio link control (RLC) channel identifier associated with the link between the source UE and the relay UE.

Aspect 9: The method of Aspect 5, further comprising setting, by a sidelink relay adaptation protocol (SRAP) layer of the source UE, the route identifier for the sidelink communication to be equal to the route identifier obtained from the proximity services layer of the source UE, wherein the sidelink communication is associated with an end-to-end (E2E) unicast link between the source UE and the relay UE.

Aspect 10: The method of Aspect 9, further comprising setting, by the SRAP layer of the source UE, a bearer identifier for the sidelink communication to be equal to an E2E sidelink (SL) data radio bearer (DRB) identifier associated with the link between the source UE and the relay UE.

Aspect 11: The method of Aspect 10, where in the sidelink communication corresponds to E2E SL DRB data and is supported using a bearer mapping configuration between the E2E SL DRB identifier and a PC5 radio link control (RLC) channel identifier associated with the link between the source UE and the relay UE.

Aspect 12: The method of any of Aspects 1-11, wherein a proximity services layer of the source UE provides the route identifier to an access stratum layer of the source UE to be used with one or more sidelink PC5 messages.

Aspect 13: The method of any of Aspects 1-12, wherein a proximity services layer of the source UE provides the route identifier to an access stratum layer of the source UE as part of E2E unicast link information, wherein the E2E unicast link information includes at least one of a layer 2 identifier or a quality of service indicator.

Aspect 14: A method of wireless communication performed by a relay user equipment (UE), comprising: identifying, for relaying a sidelink communication between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE; and transmitting a sidelink communication, to the destination UE or another relay UE, that includes the route identifier.

Aspect 15: The method of Aspect 14, further comprising: obtaining, by an access stratum layer of the relay UE from a proximity services layer of the relay UE, routing information for sidelink relay adaptation protocol (SRAP) layer relaying between a source UE and another relay UE; receiving a sidelink communication from the source UE; and relaying the sidelink communication to the other relay UE or a destination UE using the routing information.

Aspect 16: The method of Aspect 15, wherein obtaining the routing information comprises assigning the route identifier for a link between the source UE and the destination UE and transmitting an indication of the route identifier to the source UE during a per-hop unicast link setup or modification between the relay UE and the source UE.

Aspect 17: The method of Aspect 15, further comprising transmitting an indication of the route identifier to the other relay UE during a per-hop unicast link setup or modification between the relay UE and the other relay UE.

Aspect 18: The method of any of Aspects 14-17, wherein the relay UE is a first-hop relay UE from the source UE, and wherein the route identifier is used for each hop between the source UE and the destination UE.

Aspect 19: The method of any of Aspects 14-18, wherein two or more hops between the source UE and the destination UE are associated with different route identifiers.

Aspect 20: The method of any of Aspects 14-19, further comprising maintaining, by the relay UE, a mapping between the route identifier and the source UE and destination UE identifiers, where the source UE and destination UE identifiers include at least one of user information, E2E unicast link layer 2 identifiers, or per-hop unicast link layer 2 identifiers.

Aspect 21: The method of any of Aspects 14-20, wherein routing information maintained by the relay UE includes a mapping of an ingress per-hop link identifier to egress per-hop link identifier.

Aspect 22: The method of Aspect 21, wherein a proximity services layer of the relay UE provides the ingress per-hop link to egress per-hop link identifier to an access stratum layer of the relay UE using next-hop routing information that is included in a routing table for a source UE and destination UE pair.

Aspect 23: The method of any of Aspects 14-22, wherein routing information maintained by the relay UE includes an ingress route to egress route identifier.

Aspect 24: The method of Aspect 23, wherein the ingress route to egress route identifier is associated with a link on which the sidelink communication is received.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A source user equipment (UE) for wireless communication, comprising:
at least one memory; and
at least one processor communicatively coupled with the at least one memory, the at least one processor operable to cause the source UE to:
transmit, to a relay UE for relaying to a destination UE, a sidelink communication that includes a route identifier that is associated with one or more per-hop unicast link identifiers associated with a link between the source UE and the relay UE, the one or more per-hop unicast link identifiers being different than an end-to-end unicast link identifier associated with a link between the source UE and the destination UE.

2. The source UE of claim 1, wherein the route identifier for a current hop between the source UE and the relay UE is the same as a route identifier used for each of one or more other hops.

3. The source UE of claim 1, wherein the at least one processor is further operable to cause the source UE to receive an indication of the route identifier from the relay UE.

4. The source UE of claim 1, wherein the at least one processor is further operable to cause a proximity services layer of the source UE to determine the route identifier.

5. The source UE of claim 4, wherein the at least one processor is further operable to cause the source UE to:
obtain, by a proximity services layer of the source UE, an end-to-end unicast link layer
two (L2) identifier associated with the link between the source UE and the destination UE and a
per-hop unicast link L2 identifier associated with the link between the source UE and the relay UE;
provide, by the proximity services layer of the source UE to an access stratum layer of the source UE, at least the per-hop unicast link L2 identifiers; and
obtain, by the access stratum layer of the source UE, the route identifier.

6. The source UE of claim 5, wherein the at least one processor is further operable to cause the source UE to:
set, by a sidelink relay adaptation protocol (SRAP) layer of the source UE, the route
identifier for the sidelink communication to be equal to the route identifier obtained from the
proximity services layer of the source UE, wherein the sidelink communication includes an end-to-end (E2E) sidelink (SL) signaling radio bearer (SRB) packet data convergence protocol
(PDCP) protocol data unit (PDU).

7-8. (canceled)

9. The source UE of claim 5, wherein the at least one processor is further operable to cause the source UE to:
set, by a sidelink relay adaptation protocol (SRAP) layer of the source UE, the route
identifier for the sidelink communication to be equal to the route identifier obtained from the
proximity services layer of the source UE, wherein the sidelink communication is associated with an end-to-end (E2E) unicast link between the source UE and the relay UE.

10. The source UE of claim 9, wherein the at least one processor is further operable to cause the source UE to set, by the SRAP layer of the source UE, a bearer identifier for the sidelink communication to be equal to an E2E sidelink (SL) data radio bearer (DRB) identifier associated with the link between the source UE and the relay UE.

11. The source UE of claim 10, wherein the side link communication corresponds to E2E SL DRB data and is supported using a bearer mapping configuration between the E2E SL DRB identifier and a PCS radio link control (RLC) channel identifier associated with the link between the source UE and the relay UE.

12. The source UE of claim 1, wherein the at least one processor is further operable to cause the source UE to:
provide, by a proximity services layer of the source UE, the route identifier to an access
stratum layer of the source UE to be used with one or more sidelink PCS messages.

13. The source UE of claim 1, wherein the at least one processor is further operable to cause the source UE to:
provide, by a proximity services layer of the source UE to an access stratum layer of the
source UE, the route identifier as part of E2E unicast link information, wherein the E2E unicast
link information includes at least one of a layer 2 identifier or a quality of service indicator.

14. A relay user equipment (UE) for wireless communication, comprising:
at least one memory; and
at least one processor communicatively coupled with the at least one memory, the at least
one processor operable to cause the relay UE to:
identify, for relaying a sidelink communication that between a source UE and a destination UE by one or more relay UEs that include the relay UE, a route identifier that is associated with one or more per-hop unicast link identifiers associated with the source UE and the relay UE, the one or more per-hop unicast link identifiers being different than an end-to-end unicast link identifier associated with a link between the source UE and the destination UE; and
transmit a sidelink communication, to the destination UE or another relay UE, that includes the route identifier.

15. The relay UE of claim 14, wherein the at least one processor is further operable to cause the relay UE to:
obtain, by an access stratum layer of the relay UE from a proximity services layer of the
relay UE, routing information for sidelink relay adaptation protocol (SRAP) layer relaying
between a source UE and another relay UE;
receive a sidelink communication from the source UE; and
relay the sidelink communication to the other relay UE or a destination UE using the
routing information.

16. The relay UE of claim 15, wherein, to cause the relay UE to obtain the routing
information, the at least one processor is operable to cause the relay UE to assign the route
identifier for a link between the source UE and the destination UE and transmit an indication of
the route identifier to the source UE during a per-hop unicast link setup or modification between
the relay UE and the source UE.

17. The relay UE of claim 15, wherein the at least one processor is further operable to cause the relay UE to transmit an indication of the route identifier to the other relay UE during a per-hop unicast link setup or modification between the relay UE and the other relay UE.

18. The relay UE of claim 14, wherein the relay UE is a first-hop relay UE from the source UE, and wherein the route identifier is used for each hop between the source UE and the destination UE.

19. The relay UE of claim 14, wherein two or more hops between the source UE and the destination UE are associated with different route identifiers.

20. The relay UE of claim 14, wherein the at least one processor is further operable to cause the relay UE to maintain a mapping between the route identifier and the source UE and destination UE identifiers, where the source UE and destination UE identifiers include at least one of user information, E2E unicast link layer 2 identifiers, or per-hop unicast link layer 2 identifiers.

21. The relay UE of claim 14, wherein routing information maintained by the relay UE includes a mapping of an ingress per-hop link identifier to egress per-hop link identifier.

22. (canceled)

23. The relay UE of claim 14, wherein routing information maintained by the relay UE includes an ingress route to egress route identifier.

24-30. (canceled)
